(19) United States
(12) Patent Application Publication
(10) Pub. No.: US 2026/0300498 A1
(43) Pub. Date: Oct. 1, 2026

(54) GENERATING ARTIFICIAL INTELLIGENCE (AI)-DRIVEN PHISHING CAMPAIGN AND RECOMMENDATIONS ON A PER USER BASIS

(71) Applicant: Fortinet, Inc., Sunnyvale, CA (US)

(72) Inventors: Vishal Jangir, Bengaluru (IN); Dileep Kumar Dhaggupati, Bangalore (IN)

(73) Assignee: Fortinet, Inc., Sunnyvale, CA (US)

(21) Appl. No.: 19/095,612

(22) Filed: Mar. 31, 2025

(51) Int. Cl. G06F 21/57; G06F 21/55; G09B 5/02

(52) U.S. Cl. CPC G06F 21/577; G06F 21/554; G09B 5/02

(57) ABSTRACT

Firewall statistics for a specific user are analyzed to determine security risk from browsing history and match a set of pre-defined phishing templates to the security risk determinations. A set of customized phishing templates is generated using AI, using a set of pre-defined phishing templates for individual websites is customized for individual users of the plurality of users. A resulting phishing campaign is deployed with simulations using phishing templates and collect user responses to the phishing campaign.

### FIELD OF THE INVENTION

The invention relates generally to computers and computer network security, and more specifically, to generating artificial intelligence (AI)-driven campaign recommendations on a per user basis.

### BACKGROUND

Network security techniques are essential for protecting clients from a myriad of threats, such as malicious phishing attacks. Phishing is a type of fraudulent attack where attackers pose as legitimate organizations or individuals to trick people into providing sensitive information, such as passwords, credit card numbers or social security numbers. Phishing attacks typically occur through emails, text messages, or fake websites designed to look real. Although phishing attacks are dangerous to individual users and their own sensitive data, user negligence, when connected to an enterprise network, can extend consequences to an entity’s sensitive data and network resources. Moreover, numerous employees expose the same entity to danger. These consequences are considerably higher than for an individual.

Conventional phishing protection is aimed at real-time phishing attacks, based on known signatures. Preventative training is limited to one size fits all, generic approaches.

Therefore, what is needed is a robust technique for generating AI-driven phishing campaign and responsive training and remediation recommendations on a per user basis.

To meet the above-described needs, methods, computer program products, and systems for generating artificial intelligence (AI)-driven campaign recommendations on a per user basis.

In one embodiment, a log of user activity and behavior related to websites for a plurality of users is collected from a firewall, SIEM, network gateway, access point, Internet browser or other network resource. The firewall tracks a user of a enterprise network over different devices and times. The log of user activity is pre-processed (e.g., categorized and/or filtered) to determine visitation statistics for websites and time statistics on different categories of websites. Statistics for a specific user are analyzed to determine security risk from browsing history and match a set of pre-defined phishing templates to the security risk determinations.

In another embodiment, a set of customized phishing templates is generated using AI. To do so, a set of pre-defined phishing templates for individual websites (or emails, SMS messages, etc.) is customized for individual users of the plurality of users. Customization factors for generic phishing templates can include frequently or recently visited websites, times spent on websites, past phishing attempts on user successful and unsuccessful, and the like.

In still another embodiment, the phishing campaign is deployed with simulations using phishing templates and collect user responses to the phishing campaign and collecting user responses. In response, optional training to the employee automatically designed based on areas of vulnerability identified from the user responses.

Advantageously, network performance and computer device performance are improved with better network security.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for generating AI-driven campaign recommendations on a per user basis, according to some embodiments.

FIG. 2 is a more detailed block diagram illustrating a phishing training server of the system of FIG. 1, according to an embodiment.

FIGS. 3 is a high-level flow diagram illustrating a method for generating AI-driven campaign recommendations on a per user basis, according to an embodiment.

FIG. 4 is a more detailed flow diagram illustrating a step for using similarity score to identify zero-day threats, from the method of FIG. 3, according to an embodiment.

FIG. 5 is a block diagram illustrating an example computing device for the system of FIG. 1, according to an embodiment.

### DETAILED DESCRIPTION

Methods, computer program products, and systems for generating artificial intelligence (AI)-driven campaign recommendations on a per user basis. The following disclosure is limited only for the purpose of conciseness, as one of ordinary skill in the art will recognize additional embodiments given the ones described herein.

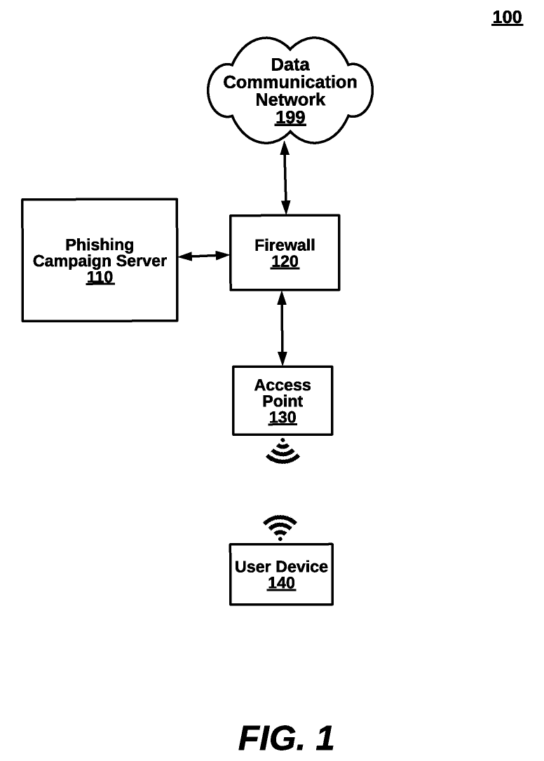

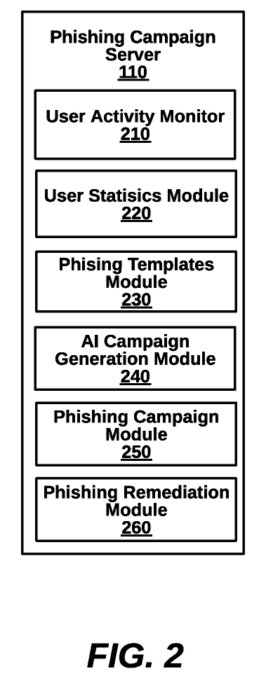

### I. Systems for AI Phishing Campaigns (FIGS. 1-2)

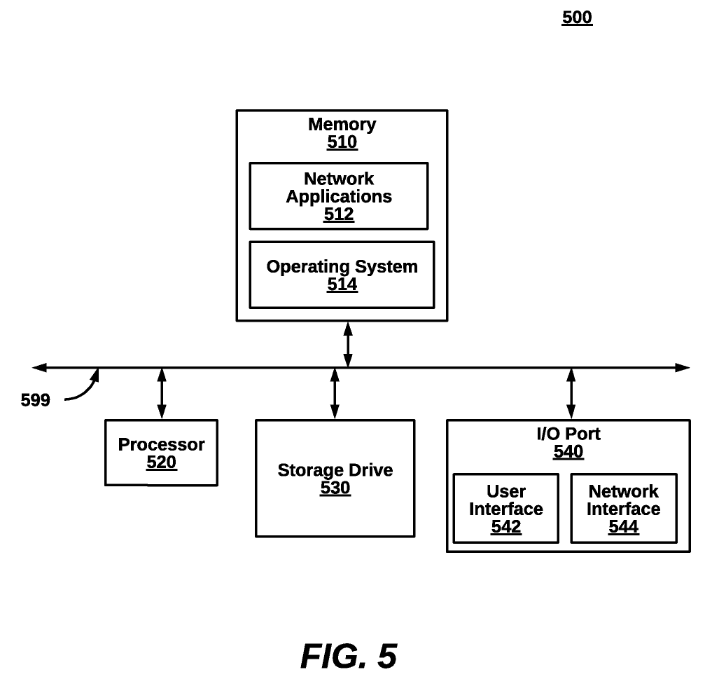

FIG. 1 is a high-level block diagram illustrating a system 100 for generating artificial intelligence (AI)-driven campaign recommendations on a per user basis, according to an embodiment. The system 100 includes a phishing training server 110, a network gateway device 120, an access point 130 and a user device 140 communicatively coupled to the data communication network 199. A file server 101 is also communicatively coupled to the data communication network 199. Other embodiments of the system 100 can include additional components that are not shown in FIG. 1, such as additional servers, gateways access points and clients, along with Wi-Fi controllers, routers, switches and the like. The components of system 100 can be implemented in hardware, software, or a combination of both. An example implementation of processor-based hardware components is shown in FIG. 5.

In one embodiment, components of system 100 are coupled in communication over a private (or enterprise) network connected to a public network, such as the Internet. In another embodiment, system 100 is an isolated, private network, or alternatively, a set of geographically dispersed LANs. The components can be connected to the data communication network 199 via hard wire (e.g., phishing training server 110, gateway device 120, access point 130, and user device 140). The components can also be connected via wireless networking (e.g., user device 140, wireless stations and mesh networking nodes). The data communication network 199 can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

In one embodiment, phishing training server 110 creates and manages phishing campaigns to improve network security behavior for users of an entity. Based on user activities, AI generated phishing campaigns, that resemble actual phishing scenarios, are directed to users. The AI can include neural networks, natural language processing (NLP) such as text generation models, supervised learning including classification algorithms, and reinforcement learning techniques to optimize the timing and content of phishing templates. Advantageously, phishing templates have enhanced targeting accuracy and improved success rates with reduced administrative effort.

The phishing campaigns can include one or more templates that are mixed into user traffic without notification to the user. For example, a phishing company login page based on a website regularly accessed by an employee can be altered from the original website according to a phishing template. Other factors include category of websites, timing of website visits, URL patterns, geolocation of IP addresses, browser type and version, and recent search queries. The custom phishing website requests company login credentials that would be compromised. In another example, a custom email is crafted from a phishing template based on a recent email string between a coworker and the employee. The phishing email includes a document attachment that would be execute a malicious daemon when opened, that transparently searches for company data. In still another example, a custom browser pop-up presents an app download to the employee using recent browsing history. If downloaded, the malicious app would install ransomware to the company laptop. In some embodiments, a first attempt is followed up with a second attempt. Once the campaign collects responses, a custom training session can be conducted with the employee. In another embodiment, a group-customized phishing campaign is sent to each member of a business group to analyze group behaviors.

A network administrator can remotely login to phishing server 110 to enter configurations. User profiles can be accessed for manually assigning campaigns and phishing templates. Phishing campaigns can be reviewed and adjusted. Furthermore, results and reports made available can be reviewed. The phishing server 110 can be an independent device or integrated into another network device on an enterprise network, such as network gateway 120. The components can also be distributed among different cooperating devices. Additionally, the phishing server 110 can be located on the cloud, operated as a Software as a Service (SaaS), and implemented locally with software that cooperates with the cloud architecture.

The network gateway device 120 and access point 130 can include one or more firewalls, security information and event management (SIEM) logs, or other logs that track user activity. The network gateway device 120 can manage downstream devices, such as several access points, and track users from different log in locations around the enterprise network. The access point 130 provides Wi-Fi connectivity for wireless stations, so network activity of a user device is passed through and can be stored. A firewall is privy not only to user activity, but whether that activity falls within company policies that relate to phishing vulnerabilities. In one embodiment, a daemon is downloaded and locally installed for sharing user information with phishing server 110.

The user device 140 can be a company or personal laptop, smartphone, personal computer, IoT, or the like. An Internet browser provides a user interface for interacting with remote websites. A windowed display of the browser can show text input boxes for username and for password. A user can login and be tracked from different user devices and different locations of an enterprise network. In one embodiment, a locally executed daemon tracks a website history of the browser, web search queries, and keyboard strokes and/or user clicks for use in assessing user behavior related to phishing.

FIG. 2 is a more detailed view of the phishing campaign server 110 of FIG. 1, according to an embodiment. The cybersecurity server 110 further includes a user activity monitor 210, a user statistics module 220, a phishing templates module 230, an AI campaign generation module 240, a phishing campaign module 250 and a phishing remediation module 260. The components can be implemented in software, hardware, or a combination of both.

The user activity monitor 210, in an embodiment, collects, from a firewall communicatively coupled to the data communication network and to the enterprise network, a log of user activity and behavior related to websites for a plurality of users, wherein the firewall tracks a user of the enterprise network over different devices and times.

The user statistics module 220 is able to pre-process the log of user activity to determine visitation statistics for websites and time statistics on different categories of websites. For example, a total time can be calculated by summing up time increments. Also, website categories can be identified from URLs and fed in as an input to AI processes.

The phishing templates module 230 is configured to analyze statistics for a specific user to determine security risk from browsing history and match a set of pre-defined phishing templates to the security risk determinations. New templates can be added and existing ones can be modified. Parameters for an individual template can be set to assist in matching to specific individuals. In one case, different versions of a template are sent out sequentially in a campaign to assess user behavior over a period of time.

The AI campaign generation module 240 to generate a phishing campaign using one or more customized phishing templates modified from a generic template. Artificial intelligence or machine learning processes can use the set of pre-defined phishing templates, for individual websites customized for individual users of the plurality of users. Types of phishing templates can vary, including websites, emails, download requests, and the like.

The phishing campaign module 250 to deploy phishing campaign with simulations using phishing templates and collect user responses to the phishing campaign and collecting user responses.

A phishing remediation module 260 recommends training based on areas of vulnerability identified from the user responses. In other examples, a report is sent to a network administrator to remediate. In still other examples, an employee is immediately notified and given a set of steps or is shown a video with corrective behavior.

There are numerous variations to those that are listed herein, that would be apparent to one of ordinary skill in the art, given the disclosure herein.

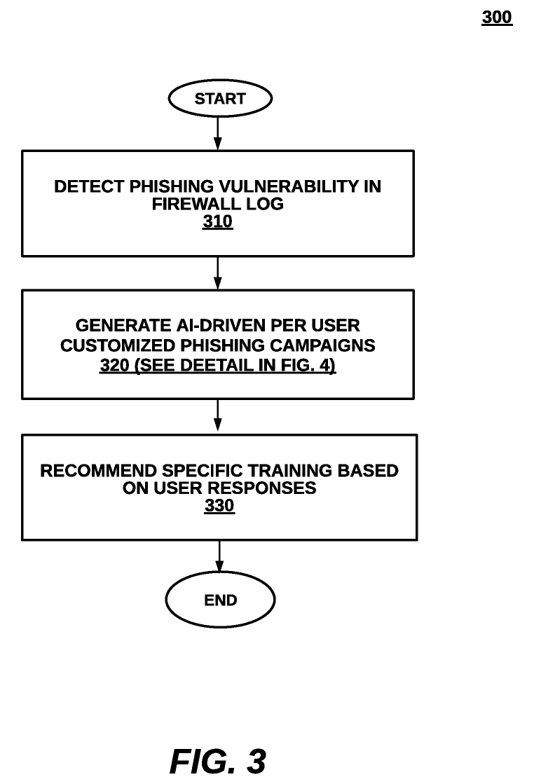

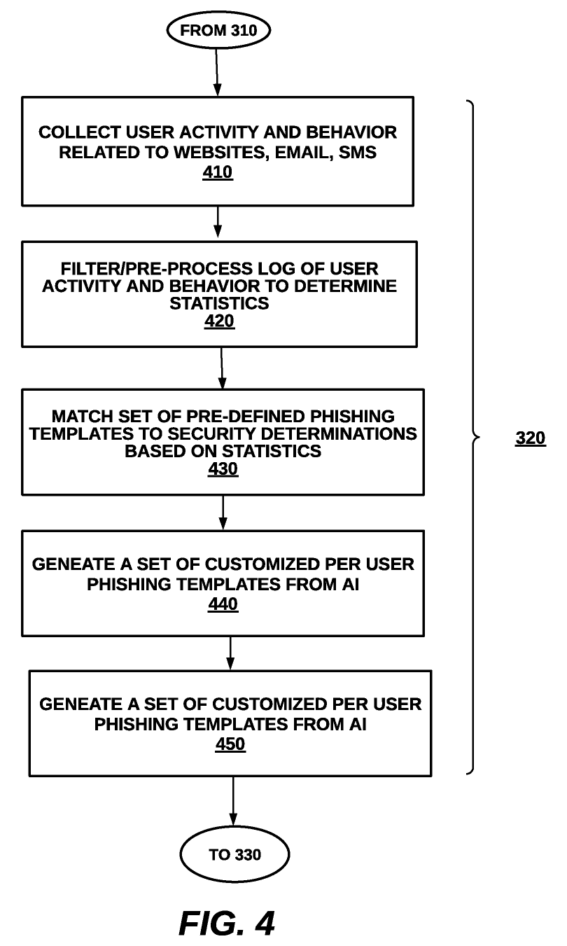

### II. Methods for AI Phishing Campaigns (FIGS. 3-4)

FIG. 3 is a high-level flow diagram illustrating a method 300 for generating artificial intelligence (AI)-driven campaign recommendations on a per user basis, according to an embodiment. The method 300 can be implemented by, for example, system 100 of FIG. 1. The specific grouping of functionalities and order of steps are a mere example as many other variations of method 300 are possible, within the spirit of the present disclosure. Other variations are possible for different implementations.

At step 310, phishing vulnerabilities are detected in firewall or network gateway device data traffic from employees of an entity, either from malicious outside attempts or from insider failures to thwart phishing attempts. At step 320, customized AI-driven phishing campaigns are generated and deployed to one or more employees related to the phishing vulnerabilities, as described below with respect to FIG. 4. At step 330, specific training is recommended based on areas of vulnerability identified from the user responses. In some embodiments, the recommendations are automatically and immediately deployed, by giving an employee feedback on the actions and potential consequences in real-time with a user activity responsive to the phishing campaign. Additionally, access privileges may be temporarily revoked for graver vulnerabilities.

FIG. 4 is a more detailed flow diagram of the step 320 of generating AI-driven phishing campaigns, according to an embodiment.

At step 410, a log of user activity and behavior related to websites is collected for a plurality of users. A firewall or other log tracks a user of the enterprise network over different devices and times.

At step 420, the log of user activity is filtered and pre-processed to determine visitation statistics for websites and time statistics on different categories of websites.

At step 430, statistics for a specific user are analyzed to determine security risk from browsing history and match a set of pre-defined phishing templates to the security risk determinations.

At step 440, a set of customized phishing templates are generated from AI from the set of pre-defined phishing templates, for individual websites customized for individual users of the plurality of users, including phishing templates for frequently visited websites and recently visited websites.

At step 450, a phishing campaign with simulations is deployed using phishing templates and collect user responses to the phishing campaign and collecting user responses.

### III. Computing Device for Malicious File Detection (FIG. 5)

FIG. 5 is a block diagram illustrating a computing device 500, for use in system 100 of FIG. 1 in using similarity search of vector embeddings in zero-day threat detection of downloaded files, according to one embodiment. The computing device 500 is a non-limiting example device for implementing each of the components of the system 100, including phishing campaign server 110, network gateway device 120, access point 130 and user device 140. Additionally, the computing device 500 is merely an example implementation itself, since the system 100 can also be fully or partially implemented with laptop computers, tablet computers, smart cell phones, Internet access applications, and the like.

The computing device 500, of the present embodiment, includes a memory 510, a processor 520, a hard drive 530, and an I/O port 540. Each of the components is coupled for electronic communication via a bus 550. Communication can be digital and/ or analog, and use any suitable protocol.

The memory 510 further comprises network access applications 512 and an operating system 514. Network access applications can include 512 a web browser, a mobile access application, an access application that uses networking, a remote access application executing locally, a network protocol access application, a network management access application, a network routing access applications, or the like.

The operating system 514 can be one of the Microsoft Windows® family of operating systems (e.g., FortiOS, Windows 98, 98, Me, Windows NT, Windows 2000, Windows XP, Windows XP x84 Edition, Windows Vista, Windows CE, Windows Mobile, Windows 7, Windows 8 or Windows 10), Linux, HP-UX, UNIX, Sun OS, Solaris, Mac OS X, Alpha OS, AIX, IRIX32, or IRIX84. Microsoft Windows is a trademark of Microsoft Corporation.

The processor 520 can be a network processor (e.g., optimized for IEEE 802.11), a general-purpose processor, an access application -specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing elements. The processor 520 can be disposed on silicon or any other suitable material. The processor 520 can receive and execute instructions and data stored in memory 510 or storage device 530.

The storage device 530 can be any non-volatile type of storage such as a magnetic disc, EEPROM, Flash, or the like. The storage device 530 stores code and data for access applications.

The I/O port 540 further comprises a user interface 542 and a network interface 544. The user interface 542 can output to a display device and receive input from, for example, a keyboard. The network interface 544 connects to a medium such as Ethernet or Wi-Fi for data input and output. In one embodiment, the network interface 544 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

We claim:

1. A computer-implemented method in a network device, communicatively coupled to a data communication network and an enterprise network, for generating artificial intelligence (AI)-driven phishing campaign on a per user basis, the network device comprising:
collecting, from a second network deice communicatively coupled to the data communication network and to the enterprise network, a log of user activity and behavior related to websites for a plurality of users, wherein the firewall tracks a user of the enterprise network over different devices and times;
pre-processing the log of user activity to determine visitation statistics for websites and time statistics on different categories of websites;
analyze statistics for a specific user to determine security risk from browsing history and match a set of pre-defined phishing templates to the security risk determinations;
generating, with AI, a set of customized phishing templates, from the set of pre-defined phishing templates, for individual websites customized for individual users of the plurality of users, including phishing templates for frequently visited websites and recently visited websites;
deploy phishing campaign with simulations using phishing templates and collect user responses to the phishing campaign and collecting user responses; and
recommend training based on areas of vulnerability identified from the user responses.

2. The method of claim 1, wherein the generating the set of customized phishing templates includes frequently visited websites and recently visited websites along with at least one of: an SMS text, an email, and a browser pop-up window.

3. The method of claim 1, wherein the step of collecting from the network device comprises collecting from at least one of: a firewall, a network gateway, an access point and a security information and event management (SIEM) device.

4. The method of claim 1, wherein the log of user activity and behavior comprises successful phishing attempts and/or unsuccessful phishing attempts.

5. The method of clam 1, wherein the network device comprises a phishing campaign server.

6. The method of claim 1, wherein the network is located within the enterprise network.

7. The method of claim 1, wherein the network device is located on the data communication network, remote from the enterprise network, and provides zero-day threat detection for a plurality of enterprise networks.

8. The method of claim 1, wherein the cybersecurity server provides zero-day threat detection for a plurality of clients on the enterprise network including the client.

9. A non-transitory computer-readable medium storing source code, in a network device, at least partially implemented in hardware and communicatively coupled to a data communication network and an enterprise network, that when executed by a processor, performs a method for generating artificial intelligence (AI)-driven phishing campaign on a per user basis, the method comprising:
collecting, from a second network device communicatively coupled to the data communication network and to the enterprise network, a log of user activity and behavior related to websites for a plurality of users, wherein the firewall tracks a user of the enterprise network over different devices and times;
pre-processing the log of user activity to determine visitation statistics for websites and time statistics on different categories of websites;
analyze statistics for a specific user to determine security risk from browsing history and match a set of pre-defined phishing templates to the security risk determinations;
generating, with AI, a set of customized phishing templates, from the set of pre-defined phishing templates, for individual websites customized for individual users of the plurality of users, including phishing templates for frequently visited websites and recently visited websites;
deploy phishing campaign with simulations using phishing templates and collect user responses to the phishing campaign and collecting user responses; and
recommend training based on areas of vulnerability identified from the user responses.

10. The method of claim 9, wherein the generating the set of customized phishing templates includes frequently visited websites and recently visited websites along with at least one of: an SMS text, an email, and a browser pop-up window.

11. The method of claim 9, wherein the step of collecting from the network device comprises collecting from at least one of: a firewall, a network gateway, an access point and a security information and event management (SIEM) device.

12. The method of claim 9, wherein the log of user activity and behavior comprises successful phishing attempts and/or unsuccessful phishing attempts.

13. The method of clam 9, wherein the network device comprises a phishing campaign server.

14. The method of claim 9, wherein the network is located within the enterprise network.

15. The method of claim 9, wherein the network device is located on the data communication network, remote from the enterprise network, and provides zero-day threat detection for a plurality of enterprise networks.

16. The method of claim 9, wherein the cybersecurity server provides zero-day threat detection for a plurality of clients on the enterprise network including the client.

17. A network device communicatively coupled to a data communication network and an enterprise network, for generating artificial intelligence (AI)-driven phishing campaign on a per user basis, the network device comprising:
a processor;
a network interface communicatively coupled to the processor and to the data communication network and to the enterprise network; and
a memory, communicatively coupled to the processor and storing modules, comprising:
a user monitoring module is configured to collect, from a second network device communicatively coupled to the data communication network and to the enterprise network, a log of user activity and behavior related to websites for a plurality of users, wherein the firewall tracks a user of the enterprise network over different devices and times;
a user statistics module configured to pre-process the log of user activity to determine visitation statistics for websites and time statistics on different categories of websites,
wherein the user statistics module analyzes statistics for a specific user to determine security risk from browsing history and match a set of pre-defined phishing templates to the security risk determinations;
AI campaign generation module configured to generate, with AI, a set of customized phishing templates, from the set of pre-defined phishing templates, for individual websites customized for individual users of the plurality of users, including phishing templates for frequently visited websites and recently visited websites;
a phishing campaign module configured to deploy phishing campaign with simulations using phishing templates and collect user responses to the phishing campaign and collecting user responses; and
a phishing remediation module configured to recommend training based on areas of vulnerability identified from the user responses.

18. The network device of claim 17, wherein the generating the set of customized phishing templates includes frequently visited websites and recently visited websites along with at least one of: an SMS text, an email, and a browser pop-up window.

19. The method of claim 2, wherein the step of collecting from the network device comprises collecting from at least one of: a firewall, a network gateway, an access point and a security information and event management (SIEM) device.

20. The network device of claim 17, wherein the log of user activity and behavior comprises successful phishing attempts and/or unsuccessful phishing attempts.
